(19) United States
(12) Patent Application Publication
(10) Pub. No.: US 2010/0008398 A1
(43) Pub. Date: Jan. 14, 2010

(54) Semiconductor temperature sensor

(76) Inventor: Koji Nojima, Chiba-shi (JP)

Correspondence Address: BRUCE L. ADAMS, ESQ;ADAMS & WILKS, 17 BATTERY PLACE - SUITE 1231, NEW YORK, NY, 10004, US

(21) Appl. No.: 12/459,371

(22) Filed: Jun. 30, 2009

(30) Foreign Application Priority Data
Jul. 1, 2008 (JP) 2008-172684

(51) Int. Cl. G01K 7/01

(52) U.S. Cl. 374/178

(57) ABSTRACT

Provided is a semiconductor temperature sensor capable of enhancing accuracy of temperature detection. A constant current circuit (13) of a current supply circuit (10a) causes a constant current to flow. A current mirror circuit of the current supply circuit (10a) supplies a temperature detection current from an output terminal thereof according to the constant current of the constant current circuit (13). A temperature detecting circuit (10b) outputs an output voltage according to the temperature detection current and a temperature. A PMOS transistor (19) of a leak current absorbing circuit (10c) has the same size and conductivity type as those of a PMOS transistor (15), and absorbs a leak current included in the temperature detection current (drain current of the PMOS transistor (15)).

### BACKGROUND OF THE INVENTION

1. Field of the Invention

The present invention relates to a semiconductor temperature sensor.

2. Description of the Related Art

Description is made of conventional semiconductor temperature sensors are described. FIG. 3 is a circuit diagram illustrating a conventional semiconductor temperature sensor. FIG. 4 is a circuit diagram illustrating another conventional semiconductor temperature sensor.

As illustrated in FIG. 3, a constant current circuit 53 causes a constant current to flow, and a current mirror circuit formed of PMOS transistors 54 and 55 causes a temperature detection current according to the constant current to flow through an emitter of a PNP bipolar transistor 56. A base current according to an emitter current of the PNP bipolar transistor 56 flows through an emitter of a PNP bipolar transistor 57, and a base current according to an emitter current of the PNP bipolar transistor 57 flows through an emitter of a PNP bipolar transistor 58, whereby an output voltage is output to an output terminal 52. The PNP bipolar transistors 56 to 58 have temperature characteristics, and hence the output voltage is decreased as the temperature rises while the output voltage is increased as the temperature drops. In this manner, the output voltage according to the temperature is output.

As illustrated in FIG. 4, a constant current circuit 73 causes a constant current to flow, and a current mirror circuit formed of PMOS transistors 74 to 77 causes a temperature detection current according to the constant current to flow through emitters of PNP bipolar transistors 78 to 80. Further, a base current according to an emitter current of the PNP bipolar transistor 78 also flows through the emitter of the PNP bipolar transistor 79, and a base current according to an emitter current of the PNP bipolar transistor 79 also flows through the emitter of the PNP bipolar transistor 80, whereby an output voltage is output to an output terminal 72. The PNP bipolar transistors 78 to 80 have temperature characteristics, and hence the output voltage is decreased as the temperature rises while the output voltage is increased as the temperature drops. In this manner, the output voltage according to the temperature is output (for example, see JP 05-248962 A).

However, in the conventional semiconductor temperature sensors, not only the current according to the constant current of the constant current circuit but also a leak current of the PMOS transistor is caused to flow through the PNP bipolar transistor. Accordingly, the output voltage of the PNP bipolar transistor is inaccurate by an amount of the leak current.

### SUMMARY OF THE INVENTION

The present invention has been made in view of the above-mentioned problem, and therefore an object thereof is to provide a semiconductor temperature sensor capable of enhancing accuracy of temperature detection.

In order to solve the above-mentioned problem, the present invention provides a semiconductor temperature sensor including: a current supply circuit for supplying a temperature detection current from an output terminal thereof according to a constant current of a constant current circuit; a temperature detecting circuit connected to the output terminal of the current supply circuit, for outputting an output voltage according to the temperature detection current and a temperature; and a leak current absorbing circuit connected to the output terminal of the current supply circuit, for absorbing a leak current included in the temperature detection current.

According to the present invention, the leak current absorbing circuit absorbs the leak current included in the temperature detection current, and thus the leak current is less likely to flow through the temperature detecting circuit. For this reason, the output voltage of the temperature detecting circuit is less likely to depend on the leak current, which makes the output voltage accurate.

### BRIEF DESCRIPTION OF THE DRAWINGS

In the accompanying drawings:

FIG. 1 is a circuit diagram illustrating a semiconductor temperature sensor according to a first embodiment of the present invention;

FIG. 2 is a circuit diagram illustrating a semiconductor temperature sensor according to a second embodiment of the present invention;

FIG. 3 is a circuit diagram illustrating a conventional semiconductor temperature sensor; and

FIG. 4 is a circuit diagram illustrating another conventional semiconductor temperature sensor.

### DETAILED DESCRIPTION OF THE PREFERRED EMBODIMENTS

Hereinafter, embodiments of the present invention are described with reference to the drawings.

### First Embodiment

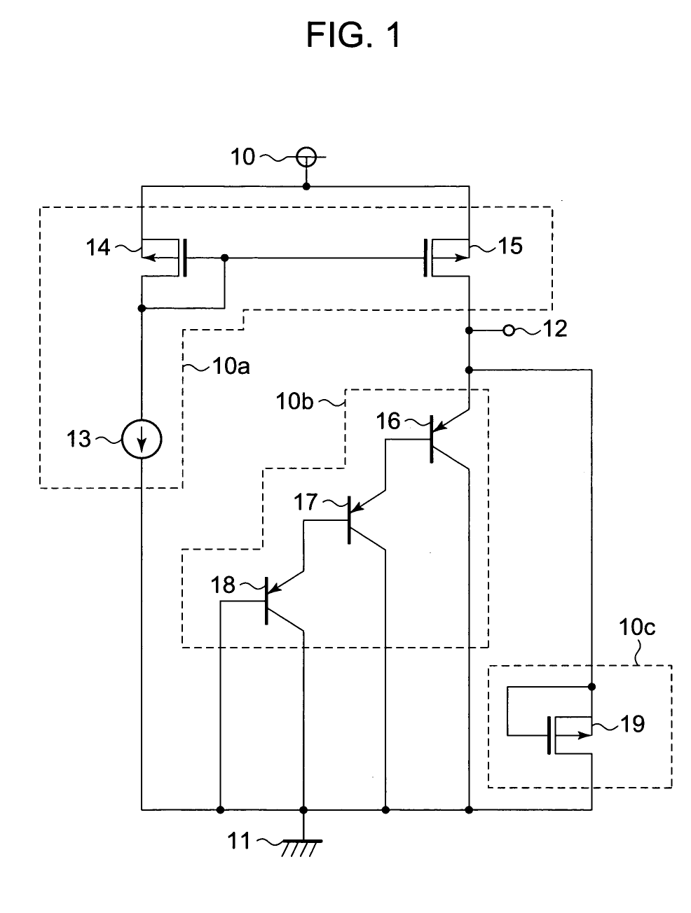

First, a configuration of a semiconductor temperature sensor is described. FIG. 1 is a circuit diagram illustrating a semiconductor temperature sensor according to a first embodiment of the present invention.

The semiconductor temperature sensor includes a constant current circuit 13, PMOS transistors 14 and 15, PNP bipolar transistors 16 to 18, and a PMOS transistor 19. The semiconductor temperature sensor further includes a power supply terminal 10, a ground terminal 11, and an output terminal 12.

The PMOS transistors 14 and 15 form a current mirror circuit. The constant current circuit 13 and the PMOS transistors 14 and 15 form a current supply circuit 10a. The PNP bipolar transistors 16 to 18 form a temperature detecting circuit 10b. The PMOS transistor 19 forms a leak current absorbing circuit 10c.

The PMOS transistor 14 has a gate and a drain connected to a gate of the PMOS transistor 15 and to an output terminal of the constant current circuit 13, and a source connected to the power supply terminal 10. The PMOS transistor 15 has a source connected to the power supply terminal 10 and a drain connected to the output terminal 12.

The PNP bipolar transistor 16 has a base connected to an emitter of the PNP bipolar transistor 17, an emitter connected to the output terminal 12, and a collector connected to the ground terminal 11. The PNP bipolar transistor 17 has a base connected to an emitter of the PNP bipolar transistor 18 and a collector connected to the ground terminal 11. The PNP bipolar transistor 18 has a base and a collector connected to the ground terminal 11.

The PMOS transistor 19 has a gate and a source connected to the drain of the PMOS transistor 15 and a drain connected to the ground terminal 11.

The constant current circuit 13 of the current supply circuit 10a causes a constant current to flow. The current mirror circuit of the current supply circuit 10a supplies a temperature detection current from an output terminal thereof according to the constant current of the constant current circuit 13. The temperature detecting circuit 10b outputs an output voltage according to the temperature detection current and a temperature. The PMOS transistor 19 of the leak current absorbing circuit 10c has the same size and conductivity type as those of the PMOS transistor 15, and absorbs a leak current included in the temperature detection current (drain current of the PMOS transistor 15).

Next, an operation of the semiconductor temperature sensor is described.

The constant current circuit 13 causes the constant current to flow, and the current mirror circuit formed of the PMOS transistors 14 and 15 causes the temperature detection current according to the constant current to flow through the emitter of the PNP bipolar transistor 16. A base current according to an emitter current of the PNP bipolar transistor 16 is caused to flow through the emitter of the PNP bipolar transistor 17, and a base current according to an emitter current of the PNP bipolar transistor 17 is caused to flow through the emitter of the PNP bipolar transistor 18, whereby an output voltage is output to the output terminal 12. The PNP bipolar transistors 16 to 18 have temperature characteristics, and hence the output voltage is decreased as the temperature rises while the output voltage is increased as the temperature drops. In this manner, the output voltage according to the temperature is output.

On this occasion, the PMOS transistor 15 supplies the temperature detection current including a channel leak current between the source and the drain thereof, a junction leak current between an N-type well (or N-type substrate) and the drain thereof, and a current according to the constant current of the constant current circuit 13. However, the PMOS transistor 19 causes the leak current substantially equal to the leak current of the PMOS transistor 15 to flow, with the result that almost all of the leak current of the PMOS transistor 15 is caused to flow through the PMOS transistor 19, and only the current according to the constant current of the constant current circuit 13 is caused to flow through the PNP bipolar transistor 16.

As a result, the leak current absorbing circuit 10c absorbs the leak current included in the temperature detection current, and hence the leak current is less likely to flow through the temperature detecting circuit 10b. Therefore, the output voltage of the temperature detecting circuit 10b is less likely to depend on the leak current, which makes the output voltage accurate. Here, as the temperature rises, the leak current is also increased correspondingly. Therefore, effects of the leak current absorbing circuit 10c which absorbs the leak current are enhanced as the temperature rises.

Note that the leak current absorbing circuit 10c includes the PMOS transistor 19, but may include an NMOS transistor (not shown). In such a case, the NMOS transistor has such a size as to cause the leak current substantially equal to the leak current of the PMOS transistor 15 to flow.

### Second Embodiment

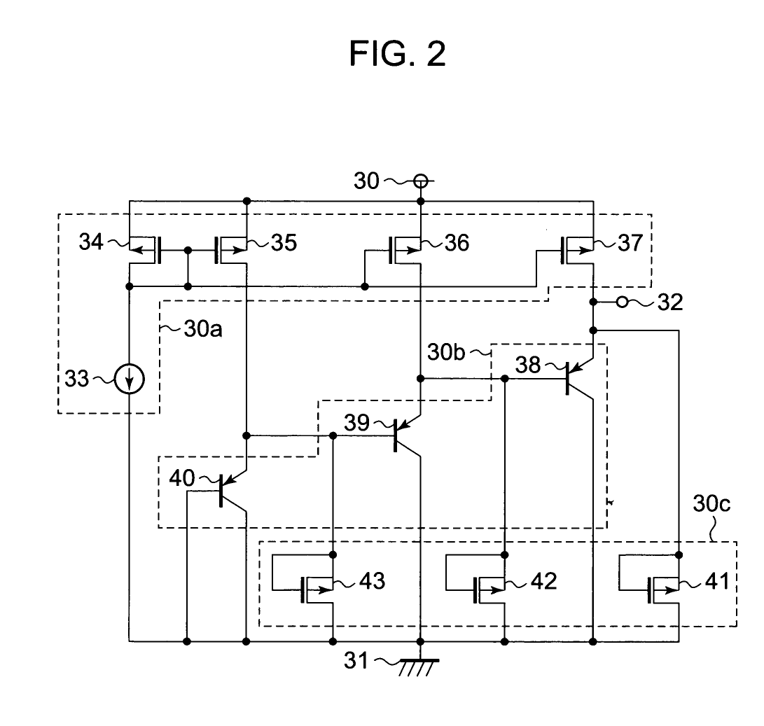

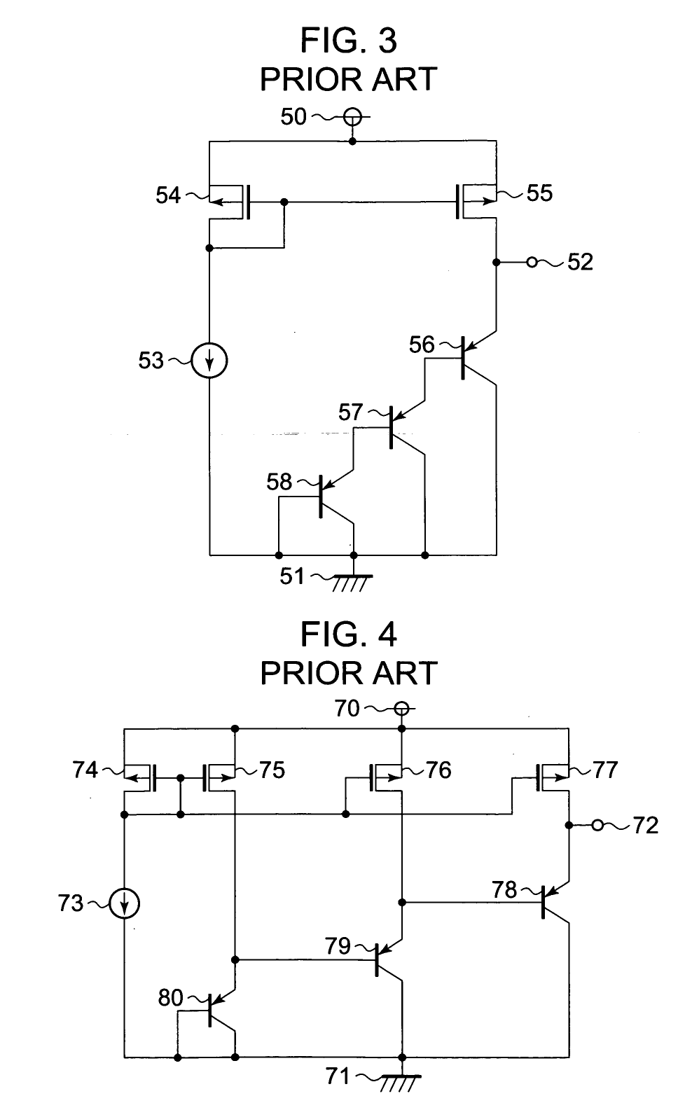

First, a configuration of the semiconductor temperature sensor is described. FIG. 2 is a circuit diagram illustrating a semiconductor temperature sensor according to a second embodiment of the present invention.

The semiconductor temperature sensor includes a constant current circuit 33, PMOS transistors 34 to 37, PNP bipolar transistors 38 to 40, and PMOS transistors 41 to 43. The semiconductor temperature sensor further includes a power supply terminal 30, a ground terminal 31, and an output terminal 32.

The PMOS transistors 34 to 37 form a current mirror circuit. The constant current circuit 33 and the PMOS transistors 34 to 37 form a current supply circuit 30a. The PNP bipolar transistors 38 to 40 form a temperature detecting circuit 30b. The PMOS transistors 41 to 43 form a leak current absorbing circuit 30c.

The PMOS transistor 34 has a gate and a drain connected to gates of the PMOS transistors 35 to 37 and to an output terminal of the constant current circuit 33, and a source connected to the power supply terminal 30. The PMOS transistor 35 has a source connected to the power supply terminal 30 and a drain connected to a base of the PNP bipolar transistor 39 and to an emitter of the PNP bipolar transistor 40. The PMOS transistor 36 has a source connected to the power supply terminal 30, and a drain connected to a base of the PNP bipolar transistor 38 and to an emitter of the PNP bipolar transistor 39. The PMOS transistor 37 has a source connected to the power supply terminal 30, and a drain connected to the output terminal 32 and to an emitter of the PNP bipolar transistor 38.

The PNP bipolar transistor 38 has a collector connected to the ground terminal 31. The PNP bipolar transistor 39 has a collector connected to the ground terminal 31. The PNP bipolar transistor 40 has a base and a collector connected to the ground terminal 31. The PMOS transistor 41 has a gate and a source connected to the drain of the PMOS transistor 37 and a drain connected to the ground terminal 31.

The PMOS transistor 42 has a gate and a source connected to the drain of the PMOS transistor 36, and a drain connected to the ground terminal 31. The PMOS transistor 43 has a gate and a source connected to the drain of the PMOS transistor 35, and a drain connected to the ground terminal 31.

The PMOS transistor 41 of the leak current absorbing circuit 30c has the same size and conductivity type as those of the PMOS transistor 37, and absorbs the leak current included in the temperature detection current (drain current of the PMOS transistor 37). The PMOS transistor 42 of the leak current absorbing circuit 30c has the same size and conductivity type as those of the PMOS transistor 36, and absorbs the leak current included in the temperature detection current (drain current of the PMOS transistor 36). The PMOS transistor 43 of the leak current absorbing circuit 30c has the same size and conductivity type as those of the PMOS transistor 35, and absorbs the leak current included in the temperature detection current (drain current of the PMOS transistor 35).

Next, an operation of the semiconductor temperature sensor is described.

The constant current circuit 33 causes the constant current to flow, and the current mirror circuit formed of the PMOS transistors 34 to 37 causes a temperature detection current according to the constant current to flow through the emitters of the PNP bipolar transistors 38 to 40. Further, a base current according to the emitter current of the PNP bipolar transistor 38 is also caused to flow through the emitter of the PNP bipolar transistor 39, and a base current according to the emitter current of the PNP bipolar transistor 39 is also caused to flow through the emitter of the PNP bipolar transistor 40, whereby the output voltage is output to the output terminal 32. The PNP bipolar transistors 38 to 40 have temperature characteristics, and hence the output voltage is decreased as the temperature rises while the output voltage is increased as the temperature drops. In this manner, the output voltage according to the temperature is output.

On this occasion, the PMOS transistor 37 supplies a temperature detection current including a channel leak current between the source and the drain thereof, a junction leak current between an N-type well (or N-type substrate) and the drain thereof, and a current according to the constant current of the constant current circuit 33. However, the PMOS transistor 41 causes the leak current substantially equal to the leak current of the PMOS transistor 37 to flow, with the result that almost all of the leak current of the PMOS transistor 37 is caused to flow through the PMOS transistor 41, and only the current according to the constant current of the constant current circuit 33 is caused to flow through the PNP bipolar transistor 38. The same holds true for the PMOS transistors 35 and 36.

Accordingly, not only the base current of the PNP bipolar transistor 38 but also the temperature detection current of the PMOS transistor 36, which contains almost no leak current, is caused to flow through the emitter of the PNP bipolar transistor 39. In addition, not only the base current of the PNP bipolar transistor 39 but also the temperature detection current of the PMOS transistor 35, which contains almost no leak current, is caused to flow through the emitter of the PNP bipolar transistor 40. For this reason, the emitter currents of the PNP bipolar transistors 38 to 40 can be made equal to each other when a mirror ratio of the current mirror circuit is appropriately adjusted, which makes the output voltage accurate.

What is claimed is:

1. A semiconductor temperature sensor, comprising:
a current supply circuit for supplying a temperature detection current;
a temperature detecting circuit connected to an output terminal of the current supply circuit, for outputting an output voltage according to the temperature detection current and a temperature; and
a leak current absorbing circuit connected to the output terminal of the current supply circuit, for absorbing a leak current included in the temperature detection current.

2. A semiconductor temperature sensor according to claim 1, wherein:
the current supply circuit includes:
a constant current circuit for causing a constant current to flow; and
a current mirror circuit for supplying the temperature detecting circuit with the temperature detection current according to the constant current; and
the leak current absorbing circuit includes a MOS transistor which has a gate and a source connected to each other and has a size and a conductivity type which are the same as a size and a conductivity type of an output MOS transistor of the current mirror circuit.

3. A semiconductor temperature sensor according to claim 1, wherein:
the current supply circuit includes:
a constant current circuit for causing a constant current to flow; and
a current mirror circuit for supplying the temperature detecting circuit with the temperature detection current according to the constant current; and
the leak current absorbing circuit includes a MOS transistor which has a gate and a source connected to each other and has a size that causes a current substantially equal to a leak current of an output MOS transistor of the current mirror circuit to flow, and a conductivity type which is different from a conductivity type of the output MOS transistor.
